(19) United States
(12) Patent Application Publication
(10) Pub. No.: US 2009/0106295 A1
(43) Pub. Date: Apr. 23, 2009

(54) Simplified system setup

(76) Inventors: Ulf Hagmann, Stockholm (SE); Magnus S.A. Josefsson, Taby (SE); Lennart Enstrom, Stockholm (SE); Kristoffer Vinge, Alta (SE); Johan Eriksson, Stockholm (SE); Carl Gentele, Stockholm (SE); Karin Windmar, Taby (SE); Lars Bjorup, Stockholm (SE); Mikael Lagula, Saltsjo-Boo (SE); Jonas E. Lundberg, Farsta (SE)

Correspondence Address: NIXON & VANDERHYE, PC, 901 NORTH GLEBE ROAD, 11TH FLOOR, ARLINGTON, VA, 22203, US

(21) Appl. No.: 11/907,962

(22) Filed: Oct. 18, 2007

(51) Int. Cl. G06F 17/30

(52) U.S. Cl. 707/102; 707/E17.044

(57) ABSTRACT

The invention concerns a method, device and computer program medium for setting up a part of a computer system as well as such a computer system including a number of modules of different types using data in a number of data fields provided in a system data set. The computer program medium comprises computer program code providing data field definitions for the data fields of the system data set, said data field definitions being provided in a system data definition structure, where the system data definition structure groups the various data field definitions for the data fields of the system data set into data packages according to which modules are to use them, and the data field definitions include data enabling the generating of data handling units for handling data in the data fields of said system data set.

### TECHNICAL FIELD OF THE INVENTION

The present invention relates to computer systems. The invention more particularly relates to a method, device and computer program medium for setting up a part of a computer system as well as to such a computer system.

### DESCRIPTION OF RELATED ART

In complex computer systems, such as in trading systems, it is known that different modules providing different functionalities share data in various data fields that are stored in a database. One example of such a module is a market module where an actual trading application is provided. A module then includes a data handling unit for handling these data fields. There is also required data field handling functionality in relation to the database.

In order to provide such data handling units it is then necessary to provide data field definitions for the data fields in the system.

However, the way that such data field definitions are provided for many such systems is often not well organised. This means that an updating of the system is hard to make, in that if new modules and/or data field definitions are introduced, the handling of data by other modules and data handling units may be influenced. This means that with the introduction of new modules and new data field definitions already existing modules would have to be updated. This is often costly and requires quite a bit of effort. It is also not simple to let a customer who purchases such a system have their own special implementation of the system applied.

There is therefore a need for enabling the provision of new modules, functionality and data field definitions in a controlled way while limiting the influence on already existing modules and data handling functionality.

US 2006/0075396 and U.S. Pat. No. 7,124,145 describe trading systems where new rules can be dynamically added to the trading systems by a user.

However, for a supplier of a system, like the supplier of a trading system, it is in many cases not desirable to give the users the possibility to dynamically change the system, because then it is often hard to support the changes that have been made to the system, since they may be unknown

There is therefore a need for a system, where updates in relation to different data field definitions can be provided in an efficient and controlled manner without having to change the whole system, i.e. so that the efforts put down into the design of the system can be reused, while still avoiding uncontrolled additions to the system.

### SUMMARY OF THE INVENTION

A first aspect of the present invention concerns a method for setting up a part of a computer system, which system includes a number of modules of different types using data of a number of data fields provided in a system data set, comprising the steps of: reading data field definitions for the data fields of said system data set, said data field definitions being provided in a system data definition structure, where said system data definition structure groups the various data field definitions for the data fields of the system data set into data packages according to which modules are to use them, and generating, based on said data field definitions, data handling units for handling data in said system data set, where each data handling unit receives functionality indicated by data field definitions in at least one data package.

A second aspect of the present invention concerns a device for setting up a part of a computer system, which system includes a number of modules of different types using data in a number of data fields provided in a system data set, arranged to: read data field definitions for the data fields of said system data set, said data field definitions being provided in a system data definition structure, where said system data definition structure groups the various data field definitions for the data fields of the of the system data set into data packages according to which modules are to use them, and generate, based on said data field definitions, data handling units for handling data in said system data set, where each data handling unit receives functionality indicated by data field definitions of at least one data package.

A third aspect of the present invention concerns a computer program medium for providing a part of a computer system, which system includes a number of modules of different types using data of a number of data fields provided in a system data set, comprising computer program code providing,

data field definitions for the data fields of said system data set, said data field definitions being provided in a system data definition structure, where said system data definition structure groups the various data field definitions for the data fields of the system data set into data packages according to which modules are to use them, and

said data field definitions include data enabling the generating of data handling unit for handling data in the data fields of said system data set.

A fourth aspect of the present invention concerns a computer system comprising:

a number of modules of different types each using data of at least one of a number of data fields provided in a system data set,

at least one data handling unit for handling data in said system data set, and

at least one database comprising said data of the system data set,

wherein each data handling unit includes functionality associated with data field definitions for at least one data field of the system data set, where data field definitions for the data fields of the system data set are provided in a system data definition structure, where said system data definition structure groups the various data field definitions for the data fields of the system data set into packages according to which modules are to use them.

The present invention has the advantage of simplifying the implementation of updates in a computer system, since then only the structure concerned with modules and data fields that are of interest to update need to be updated. It is also easy to provide new modules and new data fields without modifying the basic structure. This is possible to do both for the system provider as well as various customers that purchase the system. In this way it is ensured that updates do not more than necessary influence the various functionalities that are provided. In this way it is possible to provide a flexible computer system that is easy to maintain and update. Updating can furthermore be provided in a cost-efficient manner.

It should be emphasized that the term “comprises/comprising” when used in this specification is taken to specify the presence of stated features, steps or components, but does not preclude the presence or addition of one or more other features, steps, components or groups thereof.

### BRIEF DESCRIPTION OF THE DRAWINGS

The present invention will now be described in more detail in relation to the enclosed drawings, in which:

FIG. 1 schematically shows a computer system according to the present invention, which is with advantage a trading system,

FIG. 2 shows a simplified table of reference data for provision in a database, where the data is provided in data fields of a system data set,

FIG. 3 generally shows a system data definition structure for data field definitions that define the data fields of the system data set, and

FIG. 4 schematically shows a code generator, which creates a number of data handling units based on the system data definition structure.

### DETAILED DESCRIPTION OF EMBODIMENTS

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

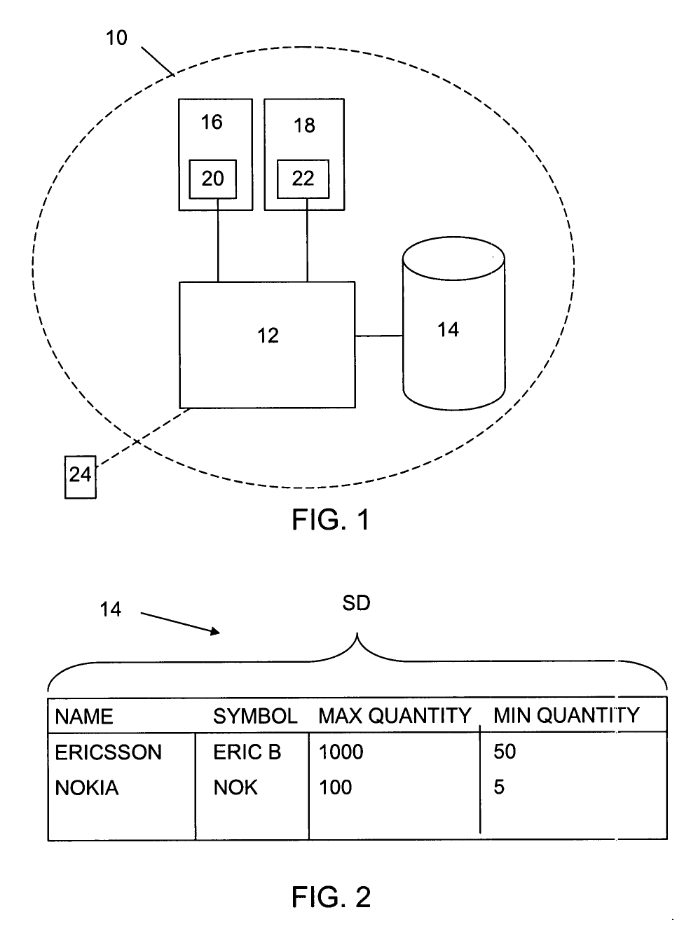

FIG. 1 schematically shows a simplified computer system 10 according to the present invention. The system 10 will in the following be described in relation to a trading system. It should however be realised that the present invention is in no way limited to a trading system, but can be used in any type of computer system.

In the system 10 there are a number of modules 16 and 18. Each of the modules is of a different type that provides a number of activities for a number of actors related to the system. Actors in a trading system can be such entities such as trading agents, stock exchanges, companies for which trading instruments are provided, authorities, information vendors etc. In FIG. 1 two modules are shown, where a first module 16 is a market module and a second module 18 is an information handling module. It should be realised that these modules are mere examples of modules that can be provided according to the present invention and that there can be many more modules. When performing activities for the various actors, these modules use system data provided in a system data set in a database 14. For this reason each module is provided with a specific data handling unit 20 and 22, which is arranged to communicate with a central data handling unit 12 which in turn accesses data in the system data set in the database 14. The central data handling unit 12 provides an interface between the database 14 and the modules 16 and 18. The market module is here a module that performs the actual trading of various instruments, while the information handling module provides information regarding the trading performed, like sending out current prices.

According to one variation of the present invention, the system data set in the database 14 is made up of reference data for the different modules, where such reference data may be definition of instruments traded, definitions of specific instruments, various limits for instruments etc. For this reason the central data handling unit 12 is often also denoted reference data manager and the specific data handling units 20 and 22 are often also denoted reference data caches.

In the figure there is furthermore provided an end user data handling unit 24, which is a graphical user interface unit GUI, via which a user of the system can access and monitor the various system data in the system data set of the data base 14.

The system data set SD in the database is shown in FIG. 2. FIG. 2 schematically shows a table including a number of data items. The system data set SD in FIG. 2 is only exemplifying and for this reason the amount of data items is kept low. It should be realised that the database may include data in various data fields. In the view in FIG. 2 there are shown four data fields, a first field, in a column “name”, which is here the name of an instrument, in this case a stock. As an example two different stocks “Ericsson” arid “Nokia” are shown. There is also a second data field named “symbol”. This second field is also associated with the stock and is the name used in the trading of the stock. There is furthermore a third data field “max quantity”. Items in this column indicate a maximum order quantity which for the stock “Ericsson” is set to 1000 and for the stock “Nokia” is set to 100. Finally there is a fourth data field, which is here “minimum quantity”, the items in this column indicate the minimum quantity of stock that can be traded and is shown as 50 for the stock Ericsson and 5 for the stock Nokia. All the data items of all the data fields are here part of the system data set. The data items in the first and second data fields are here items that are used by all modules of the system, while the items in the third and fourth column are items that are used by only one module, here the market module.

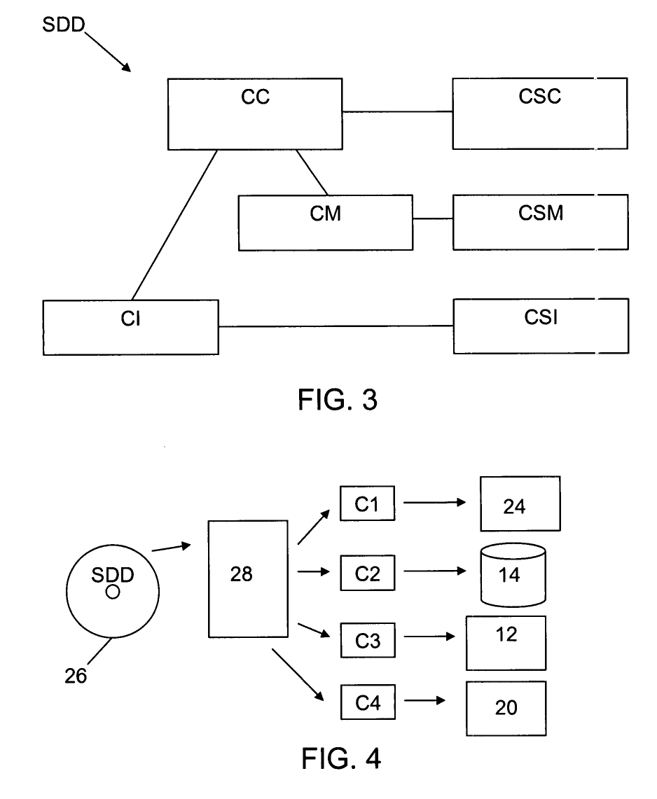

In order to provide data enabling the implementing of the system in a structured way, there is provided a system data definition structure SDD. Such a system data definition structure is generally outlined in FIG. 3. The system data definition structure SDD includes data field definitions defining the data fields of the system data set. Here the data field definitions include information that enables the generation of the various data handling units and the database in the system. According to the present invention there are therefore a number of data packages CC, CM, CI, CSC, CSM, CSI in this system data definition structure SDD. Each data package here includes data field definitions for one or more data fields in the system data set. Each package thus provides data field definitions for a group of the data fields, which group may be limited to one data field, but may also include more data fields. According to the present invention these packages, i.e. groupings of data field definitions, are provided based on the modules that are to use them. As an example there are here the Core Common CC, Core Market CM and Core Info CI data packages. The Core Common CC package, which is a first package, includes first data field definitions that are common for all the modules in the system. The first data field definitions thus define data fields in the system data set that are used by all modules in the system. The data package Core Market CM, which is a second package, includes second data field definitions that are dedicated to one type of module. These second data field definitions thus define data fields that are only used by one module, which in the example of the Core Market CM package is the market module. Core Info CI is another second package that likewise includes second data field definitions. However these are here related to the information handling module. The first data package Core Common CC is furthermore always provided, while the second data packages CI and CM are provided based on if the corresponding modules are to be provided in the system or not. The data package Core Common CC is furthermore a basic package required by all modules, while the other packages Core Market CM and Core Info CI are dependent on this basic package and linked to the Core Common package. The Core Common CC package thus provide data enabling the generation of data handling functionality or data fields used by all modules of a system while the second packages, here Core Market CM and Core Info CI, provide data enabling the generation of data handling functionality for specific modules of a system. The data field definitions can furthermore be grouped into entities, where all the entities may include one or more such field definitions and some field definitions may appear in more than one entity.

Each data package includes information regarding the data fields that are supported and the data types of these data fields. The data field definitions in a data package this gives information in the form of structural language expressions, which may be XML, that enables the provision of all data handling units in case of the Core Common data package or a specific data handling unit in the case of Core Market CM or Core Info CI data package and the creation of the database for the data fields covered by this package. In FIG. 3 there is a set of further data packages, also denoted third data packages: Customer Specific Common CSC, Customer Specific Market CSM and Customer Specific Info CSI. These packages are additional data packages that include third data field definitions enabling the creation of customer specific functionality for handling the data fields of a first and/or a second data package in a specific way for a customer. They also allow the extension of new customer specific data fields to a module. These third data packages can therefore be seen as add-on functionality to the first and second data packages. They are thus dedicated to a specific client version of at least one module. The data package Customer Specific Common CSC is thus linked to the data package Core Common CC, the data package Customer Specific Market CSM is linked to the data package Core Market CM and the data package Customer Specific Info CSI is linked to the data package Core Info CI. A customer specific data package can thus not be provided without the corresponding first or second package. The customer specific data packages thus enable the creation of customer specific versions of the first and/of second data packages. In this way it is possible to let customers, i.e. users that purchase the system, to use the data fields according to their own specific requirements but without changing the basic structure. It should here be realised that the customer specific data packages and customer specific data fields are optional. The system may thus be provided without one, more or all of them according to the requirements of the specific customer.

Now the setting up of a system according to the present invention will be described in relation to FIG. 4, which shows a computer program medium in the form of a CD ROM disc 26 as well as device 28 for generating the data handling units of the system, where the system data in the system data set is reference data for the modules. This device 28 is in this case often also denoted a code generator, which may be a source code generator. The computer program medium includes the system data definition structure SDD that has been outlined in FIG. 3. The system data definition structure SDD may here be provided as one or more data files. It is therefore possible to provide one file per data package and these files are with advantage XML files. It is here possible to edit the various data package files in order to create new data field definitions.

According to the invention the source code generator 28 reads the system data definition structure SDD from the medium 26. It then reads the data packages/files one by one and creates one big file in which the above described information of each package is provided together with an indication of the data handling unit that is to be created. When all data package files have been read the generator 28 generates code that provides functionality for the various data handling units as well as for creating the database. The generator 28 thus generates code C1 that handles the data fields in the GUI 24, code C2 for creating the database 14, i.e. for building the tables in the database 14, code C3 for handling all the data fields in the central data handling unit 12 as well as code C4 for handling the data in the specific data handling units. Here there is only shown how code C4 is generated for the first specific data handling unit 20 of the market module. It should however be realised that the source code generator also generates code for the second specific data handing unit.

The central data handling unit 12 here handles all of the data fields of the system data set. It is therefore based on the data field definitions of all data packages. The specific data handling units are on the other hand only based on data field definitions in data packages that are associated with the corresponding module. This means that for instance the customer specific data handing unit of the market module is generated based on only the common data package, like Core Common and Customer Specific Common, and data packages that are specific to this module, like Core Market and Customer Specific Market. The above generated code is here normally provided as source code.

In this way the data handling units and the data base have been generated by the generator 28 based on the data field definitions. Each data handling unit has also received the functionality indicated by the various data packages. As this has been done the specific data handling units are also provided to the modules.

Thereafter the source code is compiled into binary code and after the database has been filled with the relevant reference data, the system can be put to use.

The end-user data handling units may here be accessed by an end user or exported to an end user device.

The reference data generator furthermore provides the data fields for various users of the corresponding module in views according to the system data definition structure.

With this type of organising, it is possible to easily make extensions to the system data set since then only the module that is of interest to extend can be updated, while the others remain unchanged. It is also easy to provide new modules and new data fields without modifying the basic structure. This is possible to do both for the system provider as well as various customers that purchase the system. In this way it is ensured that updates do not more than necessary influence the various functionalities that are provided. In this way it is possible to provide a flexible computer system that is easy to maintain and update. Updating can furthermore be provided in a cost-efficient manner. Since updating is done prior to the system being put in operation, it is furthermore ensured that unauthorized additions cannot be added in an uncontrolled way.

In the above described embodiment it is not possible to see where the different data field definitions from the different data packages are provided in the binary code. According to one variation of the present invention it is possible to know in what part of the binary code, the functionality associated with a certain data package is located. This enables the replacing of only this code when an update is performed. In this way further updating is simplified.

The data handling units of the present invention are, as has been described above, implemented through one or more processors together with computer program code for performing their functions. Also the source code generator is with advantage provided in this way.

While the invention has been described in connection with what is presently considered to be most practical and preferred embodiments, it is to be understood that the invention is not to be limited to the disclosed embodiments, but on the contrary, is intended to cover various modifications and equivalent arrangements. The invention is for instance not limited to reference data. It is possible to apply to any data fields that are used in a system. As mentioned above it is not necessary with customer specific packages. These are thus optional. The invention also enables the possibility to plug in a business validation function for validating the inserted data of a specified data field, with little effort. Therefore the present invention is only to be limited by the following claims.

1. Method for setting up a part of a computer system, which system includes a number of modules of different types using data in a number of data fields provided in a system data set, comprising the steps of:
reading data field definitions for the data fields of said system data set, said data field definitions being provided in a system data definition structure, where said system data definition structure groups the various data field definitions for the data fields of the system data set into data packages according to which modules are to use them, and
generating, based on said data field definitions, data handling units for handling data in said system data set, where each data handling unit receives functionality indicated by data field definitions in at least one data package.

2. Method according to claim 1, wherein the system data definition structure includes first data field definitions in a first data package, where the first data field definitions in the first data package are common for at least some modules, and second data field definitions in at least one second data package, where second data field definitions in one second data package are dedicated to one type of module.

3. Method according to claim 2, wherein the system data definition structure includes third data field definitions in at least one third data package, which third data field definitions are dedicated to a specific customer version of at least one module.

4. Method according to claim 3, wherein each third data package is linked to a corresponding first or second data package.

5. Method according to claim 2, wherein said data handling units includes at least one specific data handling unit and at least one central data handling unit and further comprising the steps of providing a specific data handling unit to a module and creating a database for said data in the system data set, where said at least one central data handling unit provides an interface between the database and the modules.

6. Method according to claim 5, wherein generating of the central data handling unit is based on data field definitions of all data packages.

7. Method according to claim 5, wherein generating of a specific data handling unit of a module is based only on data field definitions of data packages associated with the corresponding module.

8. Method according to claim 1, further comprising the step of generating, based on said system data definition structure, at least one end user data handling unit for handling said data of the system data set in an end user device via a user interface.

9. Method according to claim 1, wherein said steps are performed before the system is put to use.

10. Method according to claim 1, wherein the data in the system data set is reference data used by the modules.

11. Method according to claim 1, where the system is a trading system.

12. A device for setting up a part of a computer system, which system includes a number of modules of different types using data in a number of data fields provided in a system data set, arranged to:
read data field definitions for the data fields of said system data set, said data field definitions being provided in a system data definition structure, where said system data definition structure groups the various data field definitions for the data fields of the of the system data set into data packages according to which modules are to use them, and
generate, based on said data field definitions, data handling units for handling data in said system data set, where each data handling unit receives functionality indicated by data field definitions of at least one data package.

13. A computer program embodied on a physical storage medium for providing a part of a computer system, which system includes a number of modules of different types using data of a number of data fields provided in a system data set, comprising computer program code providing:
data field definitions for the data fields of said system data set, said data field definitions being provided in a system data definition structure, where said system data definition structure groups the various data field definitions for the data fields of the system data set into data packages according to which modules are to use them, and
said data field definitions include data enabling the generating of data handling units for handling data in the data fields of said system data set.

14. A computer program medium according to claim 13, wherein the system data definition structure includes first data field definitions in at least one data package, which first data field definitions are common for at least some modules and second date field definitions in at least one second data package, where second data field definitions in one second data package are dedicated to one type of module.

15. A computer program medium according to claim 14, wherein the system data definition structure includes third data field definitions in at least one third data package, which third data field definitions are dedicated to a specific customer version of at least one module.

16. A computer program medium according to claim 15, wherein each third data package is linked to a corresponding first or second data package.

17. A computer system comprising:
a number of modules of different types each using data in at least one of a number of data fields provided in a system data set,
at least one data handling unit for handling data in said system data set, and
at least one database comprising said data of the system data set, wherein each data handling unit includes functionality associated with data field definitions for at least one data field of the system data set, where data field definitions for the data fields of the system data set are provided in a system data definition structure, where said system data definition structure groups the various data field definitions for the data fields of the system data set into packages according to which modules are to use them.

18. A computer system according to claim 17, wherein the system data definition structure includes a data package that is common for all modules and at least one data package that is dedicated to one type of module.

19. A computer system according to claim 17, wherein a specific data handling unit is provided in a module and a central data handling unit provides an interface between the database and the modules.

20. A computer system according to claim 19, wherein the central data handling module includes functionality associated with data field definitions in all data packages of the system data definition.

21. A computer system according to claim 19, wherein a specific data handling unit includes functionality based only on data field definitions in data packages associated with the corresponding module.

22. A computer system according to claim 17, wherein all data handling units are provided as source code.

23. A computer program medium according to claim 17, wherein all data handling units are provided as binary code.
